(19) United States
(12) Patent Application Publication
(10) Pub. No.: US 2024/0068592 A1
(43) Pub. Date: Feb. 29, 2024

(54) PRESSURE SAFETY VALVE INDICATOR WITH RETURN MECHANSIM

(71) Applicant: John B. King, Lockport, NY (US)

(72) Inventor: John B. King, Lockport, NY (US)

(21) Appl. No.: 17/822,853

(22) Filed: Aug. 29, 2022

(51) Int. Cl. F16K 37/00; F16K 17/06

(52) U.S. Cl. CPC F16K 37/0041; F16K 17/06

(57) ABSTRACT

A pressure safety valve indicator arranged to be secured to a pressure safety valve discharge pipe, the pressure safety valve indicator including an indicator cylinder, a plunger arranged to move in a first direction from a retracted position within the indicator cylinder in the event of a high-pressure discharge within the pipe and to move in a second and opposite direction within the indicator cylinder when the discharge pressure drops below a predetermined level and a sensor operatively arranged to sense movement of the plunger in the event of the high pressure discharge, and to transmit a first electrical signal commencing with the beginning of the discharge and to transmit a second electrical signal when the discharge has subsided and the plunger returns to its retracted position.

### FIELD

The present disclosure relates to an indicator to be mounted on a pressure safety valve discharge pipe, in particular, an indicator that indicates when a discharge has occurred in the pressure safety valve, and also indicates the duration of the discharge event.

### BACKGROUND

A pressure safety valve is a valve that acts as a fail-safe, to remove pressure quickly from a system before catastrophe strikes. This removal of pressure is known as a discharge event. Discharge events typically route pressure from the system through a pressure safety valve into a discharge pipe, which leads to the atmosphere. A pressure safety valve is usually a last resort to release pressure if all other means to control pressure within a system have failed. When used properly, a discharge event through a pressure safety valve is a rare occurrence.

In the oil refinery industry, there are three major phases of oil and gas industry operations: upstream, midstream, and downstream. Upstream activities include raw crude oil, and natural gas production. Midstream activities include the processing, storing, and transporting of oil, natural gas, and natural gas liquids. Downstream activities include refining oil into gasoline, diesel, jet, and other fuels.

The midstream industry designation is much more prevalent in the oil industry in the United States and Canada than in the rest of the world due to large privately-owned oil pipelines and storage facilities in these countries.

Coal and nuclear power plants both use high pressure fluids as a means to generate usable electricity on a large scale. Chemical storage of gases typically requires high pressure vessels so that more moles can be stored in a vessel than would have been possible at atmospheric pressure.

Discharge events typically evacuate high pressure fluid through a pressure safety valve discharge pipe which is typically positioned in a generally horizontal direction with a slight pitch upward before taking an abrupt turn upwards to a generally vertical direction. Precipitation build-up is an issue as discharge events are relatively rare and placing any means of keeping rain water from the top of the discharge pipe such as a cupola or a horizontally oriented rain deflector is considered bad practice as back pressure can be tremendously dangerous. However, precipitation can build up and create back pressure during a discharge event, or it can be accelerated during a discharge event which can be dangerous.

All of these industries, and many more, require the continual or continuous monitoring of the pressure within their respective systems. At any given time, many systems are able to determine the pressure, but face difficulty in determining the time interval over which the discharge event has occurred. By determining the time interval in tandem with systemic measurements over the time interval, such measurements including the changes in the pressure gradient, as well as the changes in the temperature gradient, an interested party would be able to determine how much gas is discharged into the atmosphere. This quantifies what is currently estimated. Many regulatory bodies charge a fee based on this estimate, and it is the opinion of many in the industry that these regulatory bodies have a habit of over-estimating, thereby over-charging.

Thus, there is a long-felt need for an apparatus that can be integrated with existing pressure systems which can vent pressure during discharge events from the system while simultaneously tracking the duration of the discharge event.

There is also a long-felt need for an apparatus that can communicate the measured duration of the discharge event.

There is a further need for an apparatus that can drain precipitation from a pressure safety valve discharge pipe.

### SUMMARY

According to aspects illustrated herein, there is provided a pressure safety valve indicator arranged to be secured to a pressure safety valve discharge pipe, the pressure safety valve indicator comprising an indicator cylinder, a plunger arranged to move in a first direction from a retracted position within the indicator cylinder in the event of a high-pressure discharge within the pipe and to move in a second and opposite direction within the indicator cylinder when the discharge pressure drops below a predetermined level and a sensor operatively arranged to sense movement of the plunger in the event of the high pressure discharge, and to transmit a first electrical signal commencing with the beginning of the discharge and to transmit a second electrical signal when the discharge has subsided and the plunger returns to its retracted position.

In some embodiments, the first electrical signal is transmitted concurrently with the sensing of movement of the plunger in the event of the high pressure discharge. In some embodiments, the second electrical signal is transmitted concurrently with the sensing of movement of the plunger back to its retracted position. In some embodiments, the sensor is selected from the group consisting of an optical proximity sensor, an infrared proximity sensor, an acoustic proximity sensor, an inductive proximity sensor, and a capacitive proximity sensor. In some embodiments, the plunger is further arranged to move in the first direction from the retracted position to a triggered position within the cylinder in the event of the high-pressure discharge within the pipe and to move in the second and opposite direction from the triggered position to the retracted position within the cylinder when the discharge pressure drops below the predetermined level. In some embodiments, the indicator cylinder further comprising a pressure chamber, and a drainage hole, wherein the drainage hole is capable of allowing fluid flow from the pressure chamber when the plunger is in the retracted position. In some embodiments, the drainage hole is incapable of allowing fluid flow from the pressure chamber when the plunger is in the triggered position.

According to aspects illustrated herein, there is provided a pressure safety valve indicator, comprising an indicator cylinder, including a through-bore, and a drainage hole, a plunger arranged to displace in a first direction and a second direction, opposite the first direction, within the through-bore, and an automatic return device operatively arranged to bias the plunger in the second direction.

In some embodiments, the pressure safety valve indicator further comprises a sensor operatively arranged to sense movement of the plunger, wherein the sensor transmits a first electrical signal when the plunger is displaced in the first direction from a retracted position to a triggered position, and a second electrical signal when the plunger is returned to the retracted position. In some embodiments, the drainage hole is capable of allowing fluid flow from the through-bore when the plunger is in the retracted position. In some embodiments, the drainage hole is incapable of allowing fluid flow from the through-bore when the plunger is in the triggered position. In some embodiments, the first electrical signal is transmitted concurrently with the sensing of movement of the plunger to the triggered position. In some embodiments, the second electrical signal is transmitted concurrently with the sensing of movement of the plunger back to the retracted position.

In some embodiments, the sensor is selected from the group consisting of an optical proximity sensor, an infrared proximity sensor, an acoustic proximity sensor, an inductive proximity sensor, and a capacitive proximity sensor. In some embodiments, the automatic return device comprises a spring, wherein the spring is engaged with an end of the plunger. In some embodiments, the pressure safety valve indicator further comprises a spring compressioner operatively arranged to increase the biasing force of the spring on the plunger. In some embodiments, the plunger comprises a stopper operatively arranged to limit the displacement of the plunger. In some embodiments, the automatic return device is arranged in a return mechanism. In some embodiments, the return mechanism comprises a vent hole. In some embodiments, the automatic return device is a spring arranged axially between the return mechanism and the plunger.

A primary object of the present disclosure is to track a discharge event time interval to the user, system, monitoring facility, or a combination thereof. This time interval, designated by discharge events, can be used in tandem with pressure data to quantify the amount of gases that escape the system during a discharge event. Gases in a pressure safety valve discharge pipe are vented to the atmosphere, and thus there is a desire to track the amount of gases that are vented to the atmosphere.

It should be appreciated that tension is a force that pulls materials apart, and compression is a force that squeezes material together. The term “tensioner” herein refers to an instrument for adding tension, and the term “compressioner” herein refers to an instrument for adding compression.

It should be appreciated that a pressure safety valve is distinctly different from the current disclosure, which is a pressure safety valve indicator. A pressure safety valve is the valve that releases pressure from a system during a discharge event.

Another object of the present disclosure is to provide a pressure safety valve that can vent pressure from a system whilst communicating the duration of the discharge event from the system.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a pressure safety valve indicator secured to a discharge pipe.

FIG. 2 is a perspective view of the pressure safety valve indicator shown in FIG. 1, including a discharge pipe cutaway.

FIG. 3A is a front view of the pressure safety valve indicator shown in FIG. 1.

FIG. 3B is a side view of the pressure safety valve indicator shown in FIG. 1.

FIG. 4 is a cross-sectional view of the pressure safety valve indicator taken generally along line 4-4 in FIG. 3B, with the plunger in the retracted position.

FIG. 5 is an exploded view of the pressure safety valve indicator shown in FIG. 1, shown separated from the discharge pipe.

FIG. 6A is a side view of the pressure safety valve indicator shown in FIG. 5.

FIG. 6B is a cross-sectional view of the pressure safety valve indicator taken generally along line 6B-6B in FIG. 6A, in the triggered position.

FIG. 7 is a skeletal view of pressure safety valve indicator.

FIG. 8A is a front view of the pressure safety valve indicator.

FIG. 8B is a front view of the pressure safety valve indicator.

FIG. 9A is a cross-sectional view of the pressure safety valve indicator taken generally along line 9A-9A in FIG. 8A, in the retracted position.

FIG. 9B is a cross-sectional view of the pressure safety valve indicator taken generally along line 9B-9B in FIG. 8A, in the triggered position.

FIG. 10 is a cross-sectional view of the pressure safety valve indicator in the retracted position, taken generally along line X-X in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “connector” as used herein refers to a device that joins two physical objects together. The term is synonymous with the device labelled “20” in the drawings in U.S. Pat. No. 11,209,099 (King), which patent is incorporated by reference herein in its entirety, and called “connection” in that patent.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

It should also be appreciated that examples provided herein may conclude with “etc.,” which should be interpreted to mean viable alternatives within the scope of the named examples, such that unnamed examples would be apparent to one having ordinary skill in the art.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

It should be appreciated that the embodiments as illustrated are only one of a variety of possible embodiments of the present disclosure. It should also be appreciated that directional adjectives, such as “upper,” “lower,” “right,” “left,” and similar variations, are to be interpreted in view of the corresponding drawings and are intended to be exemplary.

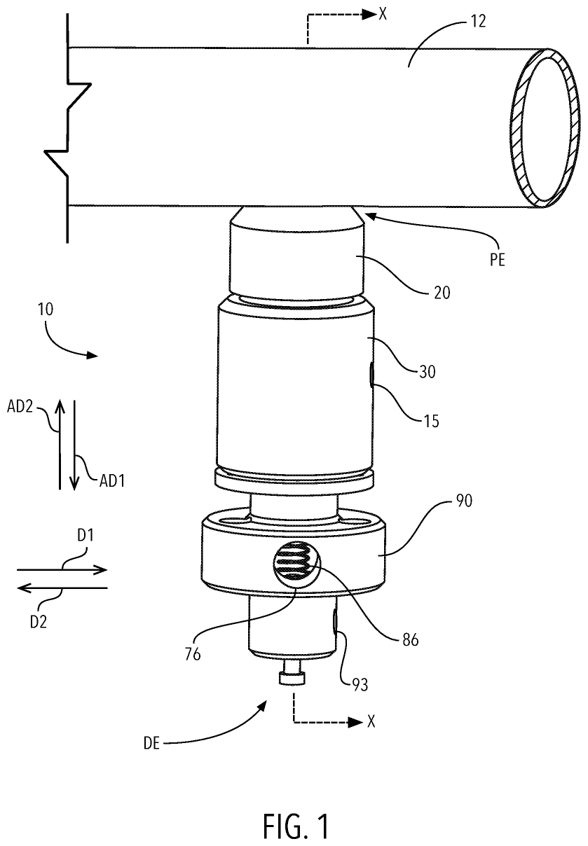

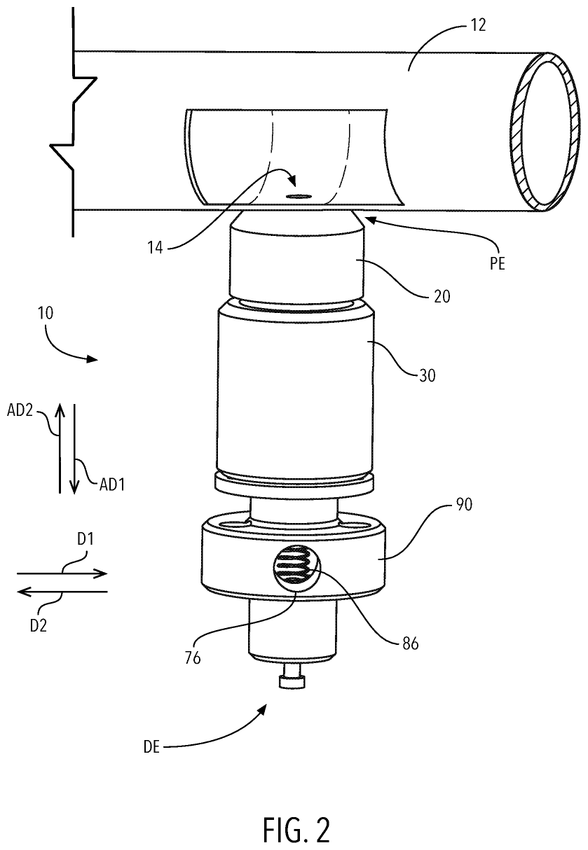

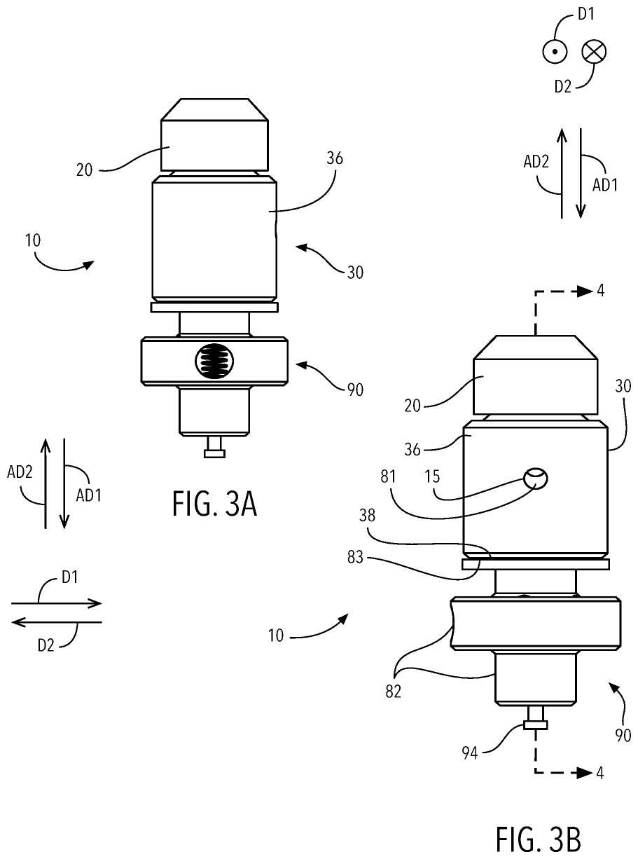

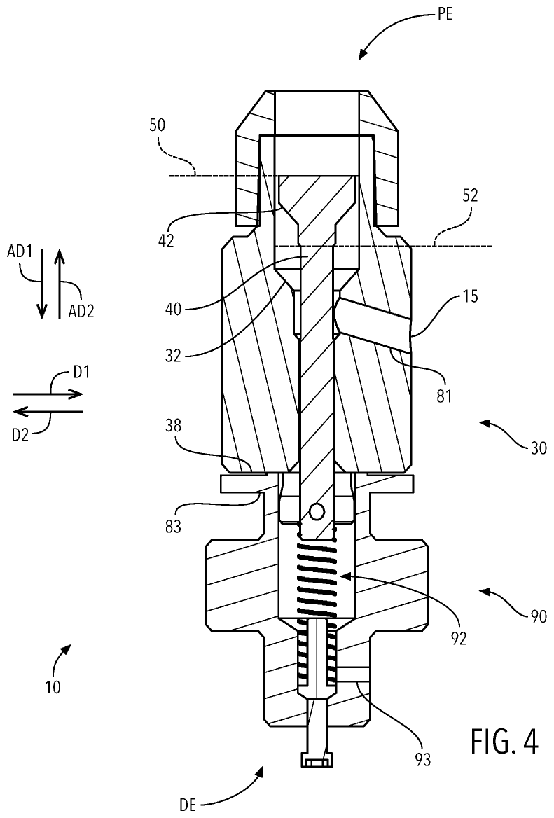

Adverting now to the figures, the following description should be taken in view of FIGS. 1 through 4. FIG. 1 is a perspective view of pressure safety valve indicator 10 affixed to discharge pipe 12. Pressure safety indicator 10 includes connector 20, indicator cylinder 30 and automatic return device 90. FIG. 2 is a perspective view of the pressure safety valve indicator shown in FIG. 1, including a discharge pipe cutaway. FIG. 3A is a front view of the pressure safety valve indicator. FIG. 3B is a side view of the pressure safety valve indicator. FIG. 4 is a cross sectional view of the pressure safety valve indicator in the retracted position, taken generally along line 4-4.

Automatic return device 90 includes return mechanism 86, and through-bore 76. In the pressure safety valve indicator, connector 20 is secured to pressure safety valve discharge pipe 12 at proximal end PE, which is opposite distal end DE. FIG. 2 includes a cutaway to illustrate through-bore 14. Pressure safety valve indicator 10 in its current embodiment is arranged to be affixed normal to the outer surface of pressure safety valve discharge pipe 12. In other embodiments, pressure safety valve indicator 10 is arranged to be non-perpendicular to the outer surface of pressure safety valve discharge pipe 12.

Radially outward facing surface 36 establishes the outer perimeter of indicator cylinder 30. Drainage hole 81 includes through bore 15. Second end 38 is fixedly secured to third end 83. Radially outward facing surface 82 establishes the outer perimeter of automatic return device 90. Spring compressioner 94 is frictionally secured to automatic return device 90.

Connector 20 is secured to discharge pipe 12 using any suitable means (e.g., welding, soldering, adhesives, etc.). As a discharge event occurs, fluid moves through pressure safety valve discharge pipe 12. The discharged fluid enters pressure safety valve indicator 10 via through-bore 14.

In retracted position 50, plunger 40 is arranged to move in axial direction AD1. During a discharge event, pressure is applied on head 42 in axial direction AD1. In an exemplary embodiment the pressure causes plunger 40 to be accelerated in axial direction AD1 until it reaches trigger position 52, where head 42 abuts seat 32. Vent hole 93 allows for air to be displaced from automatic return device 90 as plunger 40 moves to triggered position 52.

In an exemplary embodiment, return mechanism 86 includes compression spring 92 and spring compressioner 94. Spring compressioner 94 adds compression to compression spring 92 until it reaches a predetermined level.

Return mechanism 86 automatically displaces plunger 40 in axial direction AD2 from triggered position 52 to retracted position 50 at the moment when the pressure from a discharge event drops below a predetermined pressure.

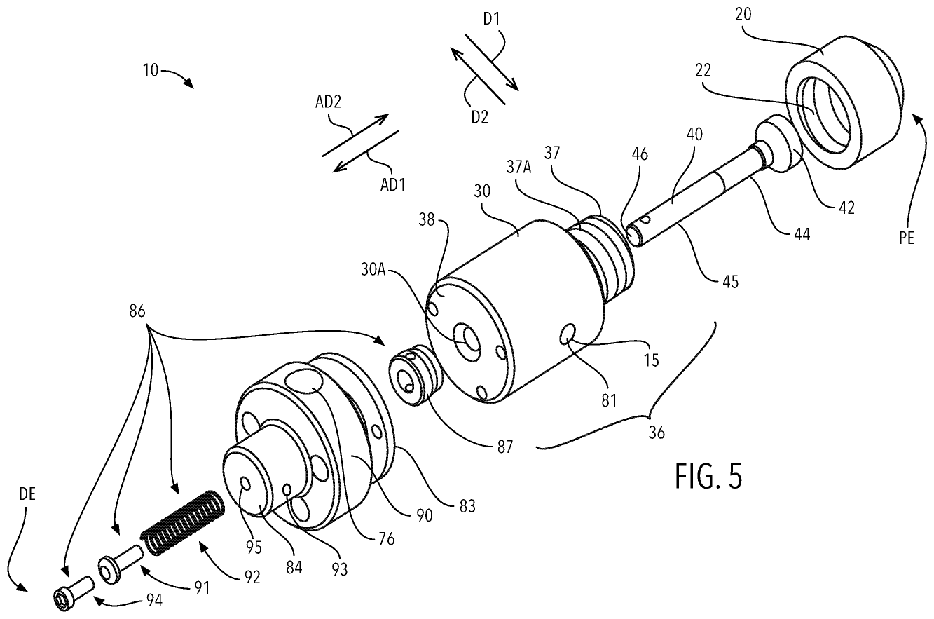

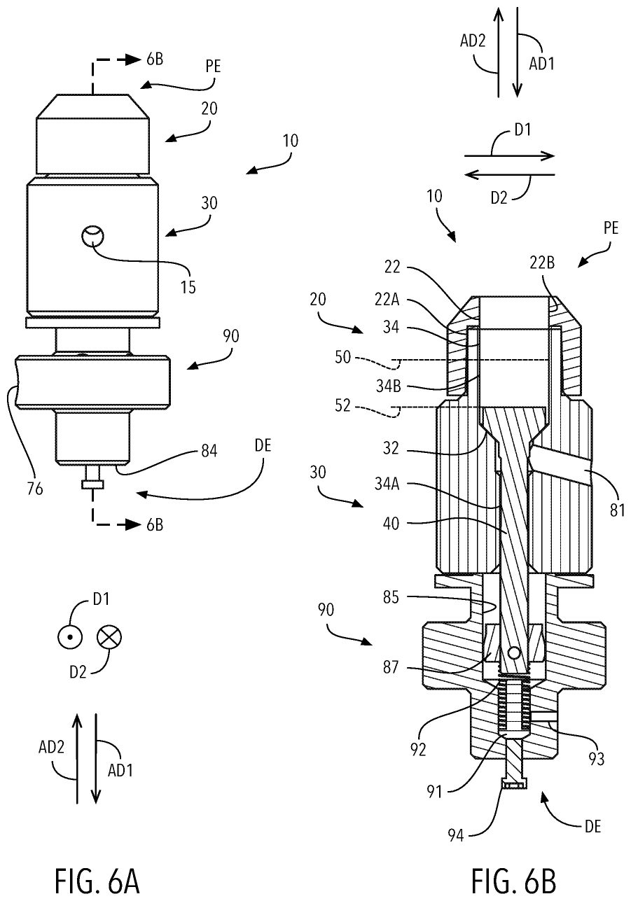

FIG. 5 is an exploded view of the pressure safety valve indicator, shown in FIG. 1. FIG. 6A is a side view of the pressure safety valve indicator. FIG. 6B is a cross sectional view of the pressure safety valve indicator in the triggered position, taken generally along line 6B-6B.

Connector 20 includes radially inward facing surface 22. In an exemplary embodiment, radially inward facing surface 22 comprises section 22A and section 22B. In an example embodiment, section 22A is threaded and section 22B is unthreaded. In an exemplary embodiment, section 22B comprises a diameter that is less than the diameter of section 22A. In an exemplary embodiment, radially inward facing surface 22 is a threaded (or socket welded) connector, such as a threadolet.

Indicator cylinder 30 is connected to connector 20. Indicator cylinder 30 comprises radially outward facing surface 36, through-bore 30A, first end 37, and second end 38. In the exemplary embodiment indicator cylinder 30 includes seat 32, and radially inward facing surface 34. Indicator cylinder 30 is inserted into connector 20 such that radially outward facing surface 36 substantially abuts radially inward facing surface 22. In an exemplary embodiment, radially outward facing surface 36 comprises threading 37A proximate first end 37. As such, indicator cylinder 30 is connected to connector 20 via threading 37A and threaded section 22A (i.e., indicator cylinder 20 is screwed into connector 20). In an exemplary embodiment, indicator cylinder 30 is inserted within radially inward facing surface 22 and welded to connector 20 using, for example, a back weld, fillet weld, socket weld, or any other suitable means of connector.

Pressure safety valve indicator also includes plunger 40, which comprises head 42, neck 44, collar 45, and fifth end 46. Collar 45 has a greater diameter than neck 44 such that collar abuts section 34A. Neck 44 preferably has a diameter arranged to allow for fluid flow from indicator cylinder 30. Indicator cylinder 30 has first end 37 and second end 38, and includes drainage hole 81 arranged therebetween. Return mechanism 86 comprises stopper 87, spring retainer 91, compression spring 92, and spring compressioner 94. Automatic return device 90 includes third end 83, fourth end 84, and through-bore 76. Spring compressioner 94 is frictionally secured within through-bore 95.

Radially inward facing surface 34 extends from first end 37 to second end 38. Through-bore 30A is bound by radially inward facing surface 34. Section 34B is a greater diameter than section 34A. Radially inward facing surface 85 serves to guide stopper 87 in direction AD1 during a discharge event. Compression spring 92 is circumferentially arranged around spring retainer 91. Spring compressioner 94 is able to adjust the position of the spring retainer 91 such that the compressive force subjected to the compression spring 92 can be increased or decreased.

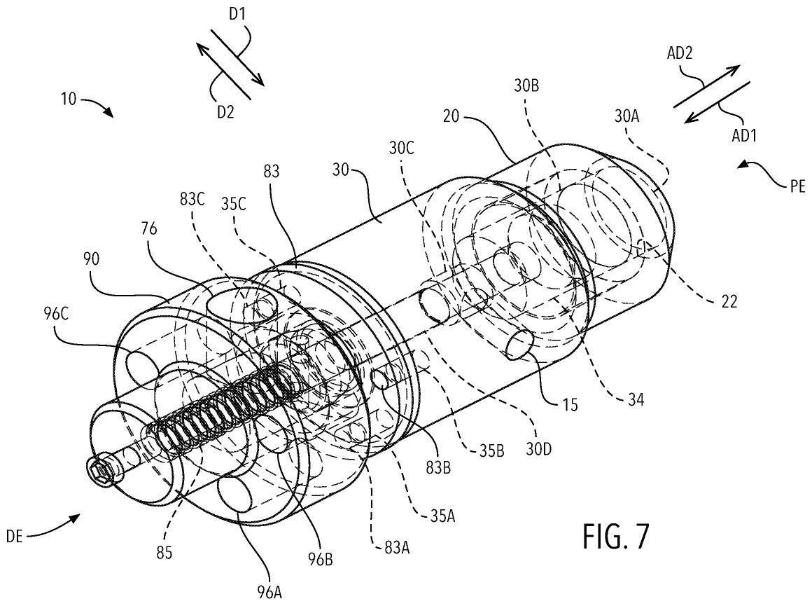

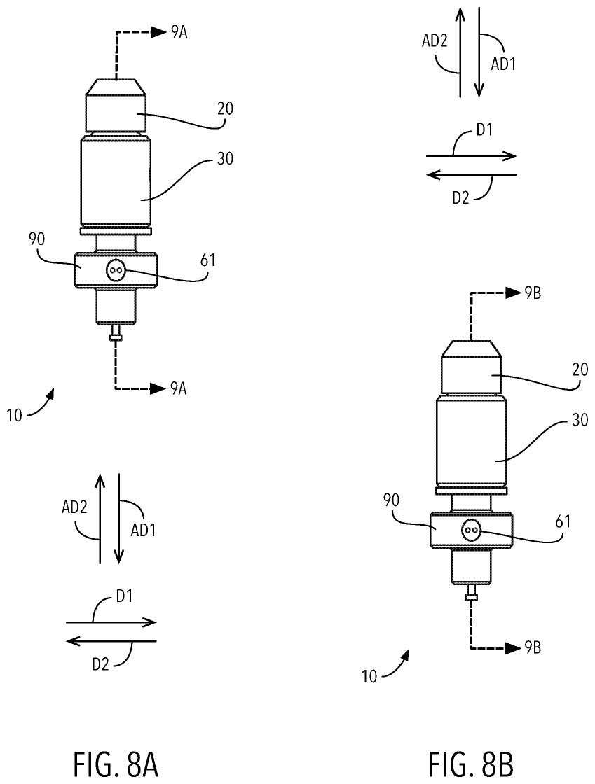

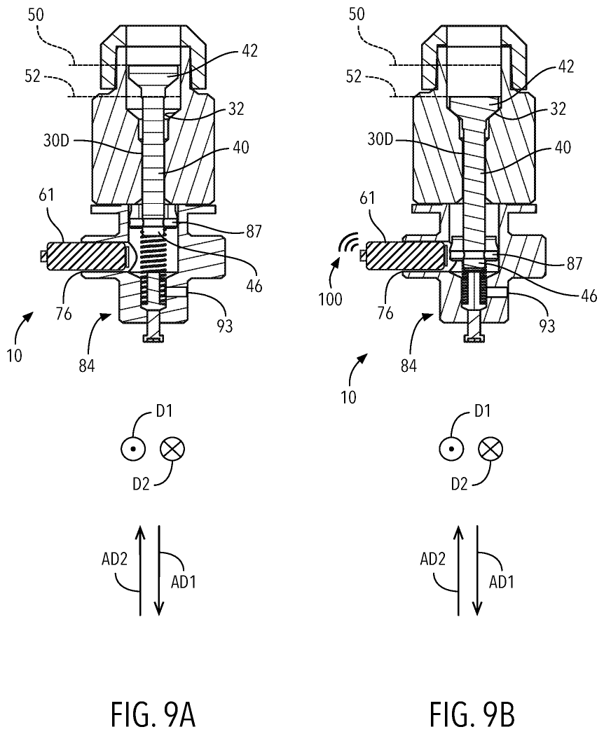

FIG. 7 is a perspective view of the pressure safety valve indicator illustrating various hidden components in broken lines. FIG. 8A is a front view of the pressure safety valve indicator. FIG. 8B is a front view of the pressure safety valve indicator. FIG. 9A is a cross sectional view of pressure safety valve indicator 10 in the retracted position, taken generally along line 9A-9A. FIG. 9B is a cross sectional view of the pressure safety valve indicator in the triggered position, i.e., arrangement of pressure safety valve indicator 10 during discharge events, taken generally long line 9B-9B.

Connector 20 is secured to pressure safety valve discharge pipe 12 over through-bore 14 drilled therein. Through-bore 14 has a calculated diameter and is drilled into pressure safety valve discharge pipe 12 for slip stream velocity control into pressure safety valve indicator 10. A discharge event causes this “slip stream” (i.e., the stream of discharge fluid that enters pressure safety valve indicator 10 through through-bore 14) to displace plunger 40 through indicator cylinder 30 in axial direction AD1, which causes head 42 to move from retracted position 50 to triggered position 52, further causing end 46, and stopper 87 which is secured thereto, into the zone where plunger 40 or stopper 87 is detected by sensor 61.

Through-bore 30A extends the full length of indicator cylinder 30. Proximal sect of through-bore 30B has a diameter that is greater than medial sect of through-bore 30B, and medial sect of through-bore 30B has a diameter that is greater than distal sect of through-bore 30C. Proximal sect of through-bore 30B allows for frictionless movement of head 42. Through-bore 15 intersects through-bore 30A at medial sect of through-bore 30C. Distal sect of through-bore 30D has collar 45 therein arranged to move in axial direction AD1 and axial direction AD2.

In the triggered position (i.e., when head 42 is aligned with triggered position line 52), after a discharge has occurred, the discharged fluid enters pressure safety valve indicator 10 via through-hole 14 and displaces head 42, and thus plunger 40, in axial direction AD1 away from pressure safety valve discharge pipe 12. Plunger 40 fully displaces such that head 42 abuts against seat 32. When head 42 abuts against seat 32, a seal is created that prevents the fluid slip stream from releasing into the atmosphere.

Automatic return device 90 is secured to indicator cylinder 30 in the exemplary embodiment via mechanical fasteners such as a bolt or a screw joining flange through-bore 83A to partial through-bore 35A, further joining flange through-bore 83B to partial through-bore 35B, and further still joining flange through-bore 83C to partial through-bore 35C. Partial through-bores 35A, 35B, and 35C in the exemplary embodiment are at least partially threaded. Driver through-bore 96A allows for a device such as a screwdriver to secure the mechanical fastener between flange through-bore 83A and partial through-bore 35A. Driver through-bore 96B allows for a device such as a screwdriver to secure the mechanical fastener between flange through-bore 83B and partial through-bore 35B. Driver through-bore 96C allows for a device such as a screwdriver to secure the mechanical fastener between flange through-bore 83C and partial through-bore 35C.

The sensing of plunger 40 or stopper 87 depends upon the type of sensor and the mechanism by which the sensor operates. In some embodiments, sensor 61 is an inductive proximity sensor, and stopper 87 is ferrous. In other embodiments, sensor 61 is an inductive proximity sensor, stopper 87 is non-ferrous, and plunger 40 is ferrous. In the former embodiment, stopper 87 interacts with the magnetic field necessary to the inductive proximity sensor's mechanism of operation. In the latter embodiment plunger 40 interacts with the magnetic field necessary to the inductive proximity sensor's mechanism of operation.

In some embodiments, sensor 61 is optical, and movement, or proximity, of stopper 87 or plunger 40, will be detected by sensor 61. In some embodiments, sensor 61 is capacitive.

The sensing by sensor 61 causes the output of signal 100. After the discharge event ends, return mechanism 86 causes plunger 40 to be displaced in axial direction AD2, which causes head 42 to move from triggered position 52 to retracted position 50, further causing stopper 87 to be displaced in axial direction AD2, further still causing signal 100 to either end completely, or change to reflect that the discharge event has ended.

Sensor 61 is typically secured within through-bore 76. In other embodiments, sensor 61 can be secured at distal end DE within through-bore 95. Sensor 61 is arranged to detect metal targets approaching the sensor, without physical contact with the target. Sensor 61 may comprise the high-frequency oscillation type of sensor using electromagnetic induction, the magnetic type of sensor using a magnet, an optical sensor that utilizes the electromagnetic spectrum, or the capacitance type of sensor using the change in capacitance. When a target approaches the magnetic field, an induction current (eddy current) flows in the target due to electromagnetic induction. As the target approaches the sensor, the induction current flow increases, which causes the load on the oscillation circuit to increase. Then, oscillation attenuates or stops. The sensor detects this change in the oscillation status with the amplitude detecting circuit, and outputs a detection signal, herein referred to as a signal 100. The nonferrous-metal type is included in the high-frequency oscillation type. The nonferrous-metal type incorporates an oscillation circuit in which energy loss caused by the induction current flowing in the target affects the change of the oscillation frequency. When a nonferrous-metal target such as aluminum or copper approaches the sensor, the oscillation frequency increases. On the other hand, when a ferrous-metal target such as iron approaches the sensor, the oscillation frequency decreases. When the oscillation frequency becomes higher than the reference frequency, the sensor outputs a detection signal, again referred to herein as a signal 100. “A signal” herein explicitly means at least one signal, and likely many more. Detection of movement can be conveyed in a multitude of ways, and the present disclosure is not bound by any one specific means of communicating that a discharge event has occurred. Rather, emphasis should be placed on the inventive step of quantifying an interval in which a discharge event has occurred, and not the means of communicating such an interval. It should be appreciated that sensor 61 may be any device, module, or subsystem capable of detecting that a discharge has occurred. In an example embodiment, sensor 61 could be embodied as a vibration sensor, a kinetic sensor, magnetic sensor, position sensor, impact sensor, or any other sensor capable of detecting a discharge or a movement of plunger 40 and the duration of the plunger in trigger position 52.

A capacitive sensor is an electronic device that can detect solid or liquid targets without physical contact. To detect these targets, capacitive sensors emit an electrical field from the sensing end of the sensor. Any target that can disrupt this electrical field can be detected by a capacitive sensor.

An optical sensor converts light rays into electronic signals. It measures the physical quantity of light and then translates it into a form that is readable by an instrument. An optical sensor is generally part of a larger system that integrates a source of light, a measuring device and the optical sensor. An infrared sensor (IR sensor) is a particular kind of optical sensor and is a radiation-sensitive optoelectronic component with a spectral sensitivity in the infrared wavelength range between 700 nm and 50 μm.

Acoustic wave sensors primary means of detection is an acoustic wave. As the acoustic wave propagates through or on the surface of the material, any changes to the characteristics of the propagation path affect the velocity and/or amplitude of the wave. Virtually all acoustic wave devices and sensors use a piezoelectric material to generate the acoustic wave. Piezoelectricity refers to the production of electrical charges by the imposition of mechanical stress. The phenomenon is reciprocal. Applying an appropriate electrical field to a piezoelectric material creates a mechanical stress. Piezoelectric acoustic wave sensors apply an oscillating electric field to create a mechanical (acoustic) wave, which propagates through the substrate and is then converted back to an electric field for measurement.

In an exemplary embodiment, sensor 61 may communicate with the transmission device via a wired or wireless connection. The transmission device is arranged to send a signal to a receiver (not shown) at a remote location indicating that a discharge has occurred. The transmission device generally comprises a transmitter and a power source. The power source is intended to be a battery or any combination of multiple batteries that can produce sufficient voltage to power the components and circuitry in the transmission device (i.e., the transmitter and sensor 61). The transmitter includes an antenna and is operatively arranged to communicate with a remote receiver (e.g., a computer, a smartphone, an iPad® tablet computer, a Surface® computer, or any other computing device) and can be utilized to send/receive a wireless signal/communication. It should be appreciated that “wireless communication(s)” as used herein is intended to mean Radio Frequency Identification (RFID) communication, Bluetooth® protocols, Near field Communication (NFC), Near Field Magnetic Inductance Communication (NFMIC), Wi-Fi, LTE, Airdrop® communication, or any other wireless protocol sufficient to communicate with the remote receiver.

In an exemplary embodiment, the transmission device further comprises a microcontroller. The microcontroller may include a memory element and a processing unit. The memory element is capable of storing a set of non-transitory computer readable instructions. The processing unit is arranged to execute the set of non-transitory computer readable instructions.

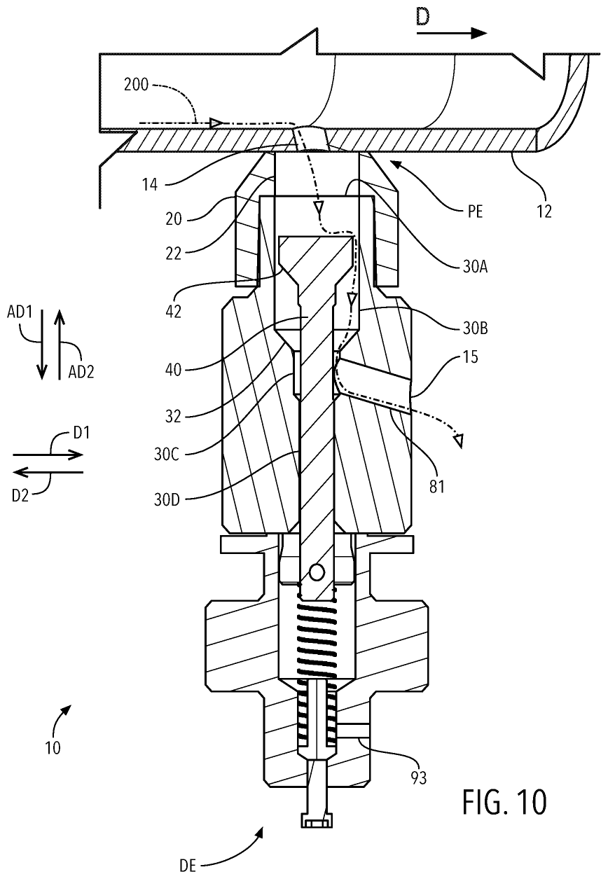

FIG. 10 is a cross sectional view of pressure safety valve indicator 10 in the retracted position, taken generally along line X-X in FIG. 1. Retracted position 50 allows for plunger 40 to be positioned such that undesired latent fluid such as water due to precipitation can be evacuated from discharge pipe 12 via general fluid flow path 200. Fluid flow begins by flowing into through-bore 14 and eventually flows into through-bore 30A, flowing around head 42 as it moves through proximal sect of through-bore 30B and then flows into medial sect of through-bore 30C into drainage hole 81. In some embodiments, drainage hole 81 allows for fluid flow to the atmosphere. In other embodiments, drainage hole 81 is threaded and connected to a drainage reservoir (not shown).

It will be appreciated that various aspects of the present disclosure and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Pressure safety valve indicator
12 Pressure safety valve discharge pipe
14 Through-bore
15 Through-bore
20 Connector
22 Radially inward facing surface
22A Section
22B Section
30 Indicator cylinder
30A Through-bore
30B Proximal Sect of Through-bore
30B Medial Sect of Through-bore
30D Distal Sect of Through-bore
32 Seat
34 Radially inward facing surface
34A Section
34B Section
35A Partial through-bore
35B Partial through-bore
35C Partial through-bore
36 Radially outward facing surface
37 End
37A Threading
38 End
40 Plunger
42 Head
44 Neck
45 Collar
46 End
50 Retracted position line
52 Triggered position line
61 Sensor
76 Through-bore
81 Drainage hole
82 Radially outward facing surface
83 End
83A Through-bore
83B Through-bore
83C Through-bore
84 End
85 Radially inward facing surface
86 Return mechanism
87 Stopper
90 Automatic return device
91 Spring retainer
92 Compression spring
93 Vent hole
94 Spring compressioner
95 Through-bore
96A Through-bore
96B Through-bore
96C Through-bore
100 Signal
200 Fluid flow path
D Direction
AD1 Axial direction
AD2 Axial direction
D1 Direction
D2 Direction

What is claimed is:

1. A pressure safety valve indicator arranged to be secured to a pressure safety valve discharge pipe, the pressure safety valve indicator comprising:
an indicator cylinder;
a plunger arranged to move in a first direction from a retracted position within the indicator cylinder in the event of a high-pressure discharge within the pipe and to move in a second and opposite direction within the indicator cylinder when the discharge pressure drops below a predetermined level; and,
a sensor operatively arranged to sense movement of the plunger in the event of the high pressure discharge, and to transmit a first electrical signal commencing with the beginning of the discharge and to transmit a second electrical signal when the discharge has subsided and the plunger returns to its retracted position.

2. The pressure safety valve indicator recited in claim 1, wherein the first electrical signal is transmitted concurrently with the sensing of movement of the plunger in the event of the high pressure discharge.

3. The pressure safety valve indicator recited in claim 1, wherein the second electrical signal is transmitted concurrently with the sensing of movement of the plunger back to its retracted position.

4. The pressure safety valve indicator as recited in claim 1, wherein the sensor is selected from the group consisting of an optical proximity sensor, an infrared proximity sensor, an acoustic proximity sensor, an inductive proximity sensor, and a capacitive proximity sensor.

5. The pressure safety valve indicator as recited in claim 1, wherein the plunger is further arranged to move in the first direction from the retracted position to a triggered position within the cylinder in the event of the high-pressure discharge within the pipe and to move in the second and opposite direction from the triggered position to the retracted position within the cylinder when the discharge pressure drops below the predetermined level.

6. The pressure safety valve indicator as recited in claim 5, wherein the indicator cylinder further comprising a pressure chamber, and a drainage hole, wherein the drainage hole is capable of allowing fluid flow from the pressure chamber when the plunger is in the retracted position.

7. The pressure safety valve indicator as recited in claim 6, wherein the drainage hole is incapable of allowing fluid flow from the pressure chamber when the plunger is in the triggered position.

8. A pressure safety valve indicator, comprising:
an indicator cylinder, including:
a through-bore; and,
a drainage hole;
a plunger arranged to displace in a first direction and a second direction, opposite the first direction, within the through-bore; and,
an automatic return device operatively arranged to bias the plunger in the second direction.

9. The pressure safety valve indicator as recited in claim 8, wherein the pressure safety valve indicator further comprises a sensor operatively arranged to sense movement of the plunger, wherein the sensor transmits:
a first electrical signal when the plunger is displaced in the first direction from a retracted position to a triggered position; and,
a second electrical signal when the plunger is returned to the retracted position.

10. The pressure safety valve indicator as recited in claim 9, wherein the drainage hole is capable of allowing fluid flow from the through-bore when the plunger is in the retracted position.

11. The pressure safety valve indicator as recited in claim 10, wherein the drainage hole is incapable of allowing fluid flow from the through-bore when the plunger is in the triggered position.

12. The pressure safety valve indicator recited in claim 9, wherein the first electrical signal is transmitted concurrently with the sensing of movement of the plunger to the triggered position.

13. The pressure safety valve indicator recited in claim 12, wherein the second electrical signal is transmitted concurrently with the sensing of movement of the plunger back to the retracted position.

14. The pressure safety valve indicator as recited in claim 9, wherein the sensor is selected from the group consisting of an optical proximity sensor, an infrared proximity sensor, an acoustic proximity sensor, an inductive proximity sensor, and a capacitive proximity sensor.

15. The pressure safety valve indicator as recited in claim 8, wherein the automatic return device comprises a spring, wherein the spring is engaged with an end of the plunger.

16. The pressure safety valve indicator as recited in claim 15, further comprising a spring compressioner operatively arranged to increase the biasing force of the spring on the plunger.

17. The pressure safety valve indicator as recited in claim 8, wherein the plunger comprises a stopper operatively arranged to limit the displacement of the plunger.

18. The pressure safety valve indicator as recited in claim 8, wherein the automatic return device is arranged in a return mechanism.

19. The pressure safety valve indicator as recited in claim 18, wherein the return mechanism comprises a vent hole.

20. The pressure safety valve indicator as recited in claim 18, wherein the automatic return device is a spring arranged axially between the return mechanism and the plunger.
